(19) United States
(12) Patent Application Publication
(10) Pub. No.: US 2002/0069143 A1
(43) Pub. Date: Jun. 6, 2002

(54) System and method for allocating operating expenses

(76) Inventor: Jose Alberto Cepeda, Stamford, CT (US)

Correspondence Address: John S. Beulick, Esq., Armstrong Teasdale LLP, Suite 2600, One Metropolitan Sq., St. Louis, MO, 63102, US

(21) Appl. No.: 09/731,161

(22) Filed: Dec. 6, 2000

(51) Int. Cl. G06F 17/60

(52) U.S. Cl. 705/30

(57) ABSTRACT

A system utilizing a web-based interactive database to automate the allocation of the operating expenses is disclosed. The system is configured to receive business information, allocate operating expenses, compute an average deal cost, calculate deal cost per product by adjusting the average deal cost to reflect complexity differences, and provide various management reports to track operating expenses by different categories to facilitate strategic decision making process. In another embodiment, the invention is a method and a computer program for allocating operating expenses that utilizes a web-based system including a server system, a centralized database and a client system.

### BACKGROUND OF THE INVENTION

This invention relates generally to a strategic decision making process and, more particularly, to network-based systems and methods for allocating operating expenses to various products and processes.

The financial management function of a business entity includes the tasks of evaluating acquisition candidates, often referred to as deals, performing financial analysis and justification, and making recommendations to the management regarding potential acquisitions. The financial management function expends substantial resources managing operating expenses as well as maintaining the operating profits and margins of the business entity. Operating expenses are typically a major business expenditure and are generally allocated to different divisions in proportion to the business revenues. Allocation of the operating expenses is a significant challenge since such an allocation must be done fairly and equitably to evaluate the performance of the business division objectively. These tasks are time-consuming and are often done manually without any fixed methodology. Such tasks, therefore, take away resources of the corporation from its operations and other profitable activities.

Therefore, it would be desirable to implement systems and processes that allocate operating expenses of the business entity using pre-defined criteria. It would be further desirable to automate the allocation of operating expense by various products and processes utilized by the business entity to maintain fairness and consistency.

### BRIEF SUMMARY OF THE INVENTION

In an exemplary embodiment, a searchable web-based system collects, tracks and disseminates real time information regarding the allocation of operating expenses to various products and processes to facilitate the strategic decision making process. A Cost Allocation Management System (CAMS) allocates operating expenses to the deal activity for a business entity. The CAMS allocates costs to a specific Business Unit's products and processes based on various data inputs. The CAMS also determines average deal unit costs, beginning and ending inventory for active deals, and total cost for terminated and closed deals. The output derived from the CAMS is utilized to calculate operational productivity and product pricing and for strategic decision making. Additionally, the CAMS helps management in the strategic decision making process and assists the management in identifying organizations where reduction of headcount is warranted. The CAMS also identifies the areas where process improvement projects can be initiated to improve productivity.

More specifically, the CAMS utilizes a web-based interactive database to automate the process for allocating operating expenses. The system includes a client system including a browser, a data storage device for storing information, and a server system configured to be coupled to the client system and the database. The system is receives business information, stores the business information, cross-references the business information against unique identifiers into a centralized database, updates the centralized database with revised business information, and provides various management reports that track operating expenses by various products and processes in response to an inquiry. The system captures all business information and provides on-line, up-to-date information upon a user request. In one exemplary embodiment, the system utilizes a Structured Query Language (SQL) server database with a client user interface front-end for administration and a web interface for standard user inputs and reports. The system includes a centralized database for use in automating documentation, monitoring and records retention activities associated with the operating expenses allocation, and the strategic decision making process.

In another embodiment, a method and a computer program for allocate operating expenses to deal activity using a web-based system including a server system coupled to a centralized database and at least one client system. The method includes inputting business information, allocating operating expenses to a business unit's processes, computing an average deal cost, calculating deal costs per product by adjusting the average deal cost to reflect complexity differences between products since each product tends to have a different level of complexity that drives different processes and costs, and providing various management reports to track operating expenses by different categories to facilitate the strategic decision making process and improve operational productivity.

### BRIEF DESCRIPTION OF THE DRAWINGS

FIG. 1 is a simplified block diagram of a Cost Allocation Management System (CAMS) in accordance with one embodiment of the present invention;

FIG. 2 is an expanded version block diagram of an exemplary embodiment of a server architecture of the CAMS;

FIG. 3 shows a configuration of the database within the database server of the server system shown in FIG. 1;

FIG. 4 is an exemplary embodiment of an organizational structure utilized by the CAMS in computing and allocating operating expenses;

FIG. 5 is an exemplary embodiment of a user interface identifying allocation of operating expenses to the business unit's processes and computation of an average deal cost;

FIG. 6 is an exemplary embodiment of a user interface identifying a Product Complexity Index;

FIG. 7 is an exemplary embodiment of a user interface depicting the overall adjustments to average deal cost based on a Product Complexity Index (shown in FIG. 6) for a loan product;

FIG. 8 is an exemplary embodiment of a user interface providing a breakdown of costs for a given product (i.e. loan) for each of the separate process steps;

FIG. 9 is an exemplary embodiment of a “T&I Operating Cost for Loans by Process” report which lists a total cost in millions of dollars;

FIG. 10 is an exemplary embodiment of a “T&I Operating Cost by Product” report which lists a total cost in millions of dollars including a breakdown for costs for various product categories including costs for Loans, Leases, Equity, Common Equity, and costs for Multi-Products;

FIG. 11 is an exemplary embodiment of a “T&I Operating Cost for All Products by Process” report which lists a total cost in millions of dollars including a breakdown for close deals costs and dead deals costs; and

FIG. 12 is a process flow chart utilized by the CAMS.

### DETAILED DESCRIPTION OF THE INVENTION

Exemplary embodiments of systems and processes that facilitate integrated network-based electronic reporting and workflow process management related to a Cost Allocation Management System (CAMS) are described below in detail. The systems and processes facilitate, for example, electronic submission of information using a client system, automated extraction of information, and web-based assessment reporting and management of resources that are involved in refueling and maintenance effort of utility customers.

The systems and processes are not limited to the specific embodiments described herein. In addition, components of each system and each process can be practiced independent and separate from other components and processes described herein. Each component and process also can be used in combination with other components and processes.

In an exemplary embodiment, the application is implemented as a Cost Allocation Centralized Database utilizing a Structured Query Language (SQL) with a client user interface front-end for administration and a web interface for standard user input and reports. The application is web enabled and is run on a business entity's intranet. In a further exemplary embodiment, the application is fully accessed by individuals having authorized access outside the firewall of the business entity through the Internet. In another exemplary embodiment, the application is run in a windows NT environment or simply on a stand alone computer system. In yet another exemplary embodiment, the application is practiced by simply utilizing spreadsheet software or even through manual process steps. The application is flexible and designed to run in various different environments without compromising any major functionality.

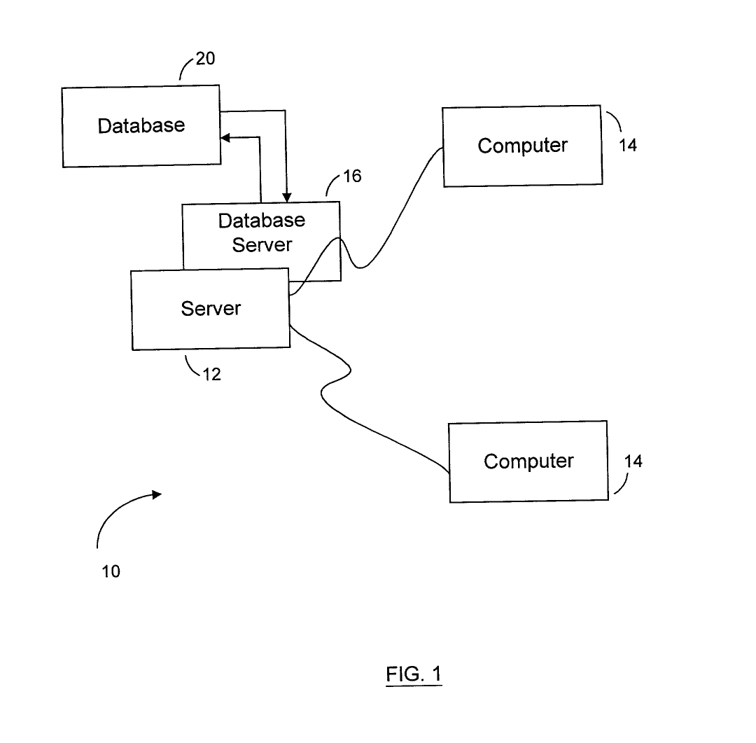

FIG. 1 is a simplified block diagram of a Cost Allocation Management System (CAMS) 10 including a server system 12 and a plurality of client systems 14 connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone or other web-based connectable equipment. A database server 16 is connected to a centralized database 20 containing product related information on a variety of products, as described below in greater detail. In one embodiment, centralized database 20 is stored on server system 12 and can be accessed by potential users at one of client systems 14 by logging on to server system 12 through one of client systems 14. In an alternative embodiment centralized database 20 is stored remotely from server system 12.

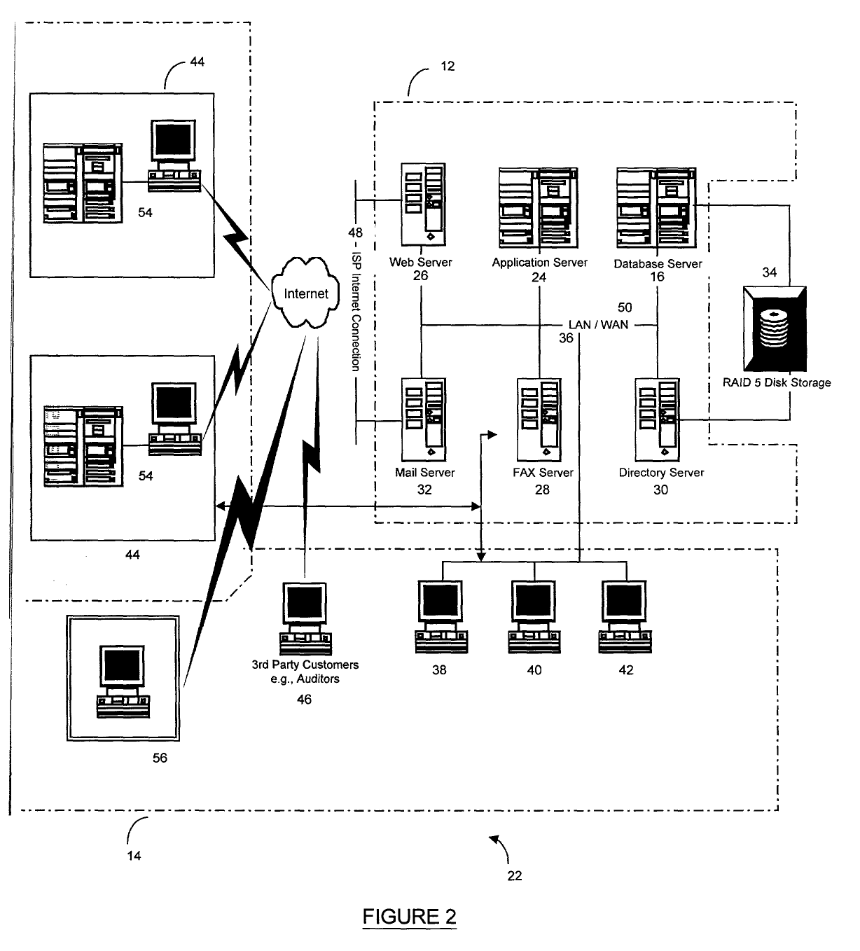

FIG. 2 is an expanded version block diagram of an exemplary embodiment of a server architecture of a Cost Allocation Management System (CAMS) 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server system 12 is configured to be communicatively coupled to various individuals or employees 44 and to third parties, e.g., internal or external auditors, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 54 can access the Cost Allocation Management System (CAMS). One of the client systems includes a senior manager's workstation 56 located at a remote location. Workstations 54 and 56 are personal computers having a web browser. Also, workstations 54 and 56 are configured to communicate with server system 12. Furthermore, fax server 28 communicates with employees located outside the business entity's 44 and any of the remotely located client systems, including a client system 56 via a telephone link. Fax server 28 is configured to communicate with other client systems 38, 40, and 42 as well.

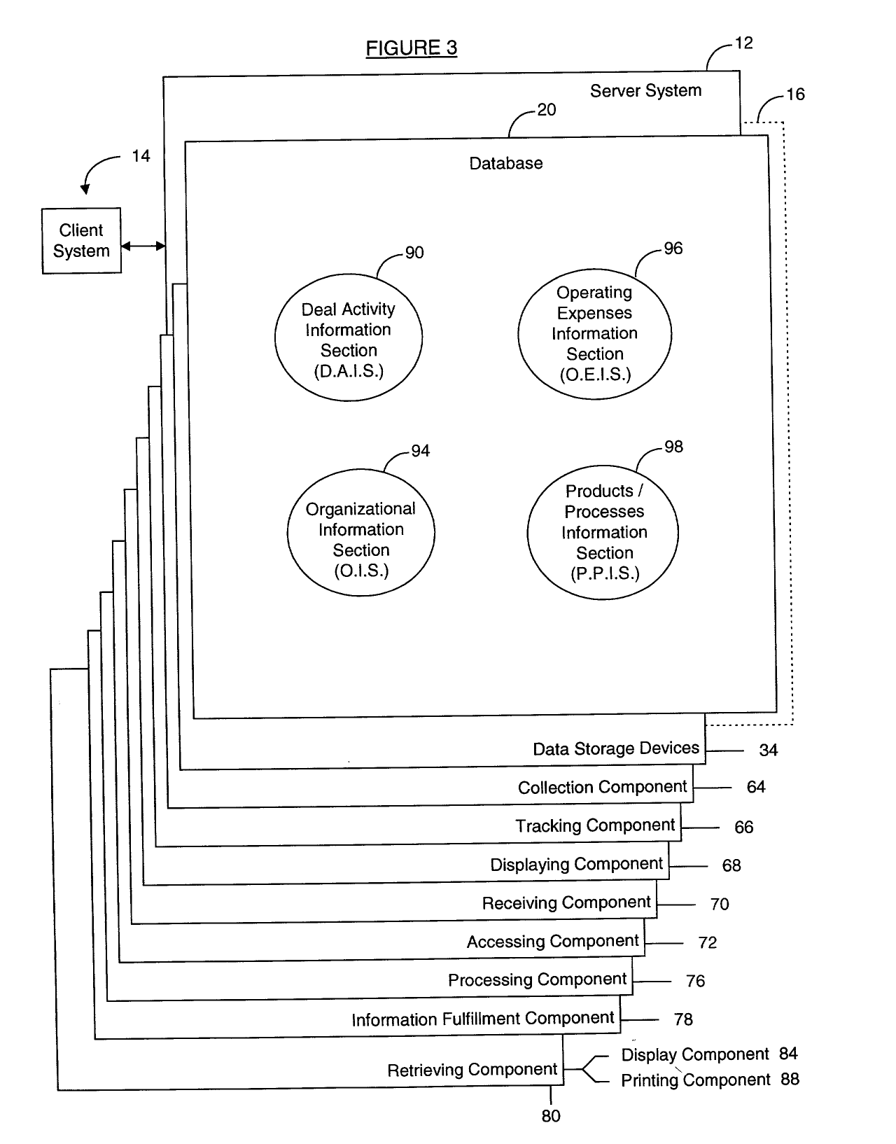

FIG. 3 shows a configuration of database 20 within database server 16 of server system 12 (shown in FIG. 1). Database 20 is coupled to several separate components within server system 12, which perform specific tasks.

Server system 12 includes a collection component 64 for collecting information from users into centralized database 20, a tracking component 66 for tracking information, a displaying component 68 to display information, a receiving component 70 to receive a specific query from client system 14, and an accessing component 72 to access centralized database 20. Receiving component 70 is programmed for receiving a specific query from one of a plurality of users. Server system 12 further includes a processing component 76 for searching and processing received queries against data storage device 34 containing a variety of information collected by collection component 64. An information fulfillment component 78, located in server system 12, downloads the requested information to the plurality of users in the order in which the requests were received by receiving component 70. Information fulfillment component 78 downloads the information after the information is retrieved from data storage device 34 by a retrieving component 80. Retrieving component 80 retrieves, downloads, and sends information to client system 14 based on a query received from client system 14 regarding various alternatives.

Retrieving component 80 further includes a display component 84 configured to download information to be displayed on a client system's graphical user interface and a printing component 88 configured to print information. Retrieving component 80 generates various reports requested by the user through client system 14 in a pre-determined format. System 10 is flexible to provide other alternative types of reports and is not constrained to the options set forth above.

Database 20 is divided into a Deal Activity Information Section (DAIS) 90, an Organizational Information Section (OIS) 94, an Operating Expenses Information Section (OEIS) 96, and a Products/Processes Information Section (PPIS) 98. These sections 90, 94, 96 and 98 within database 20 are interconnected to update and retrieve the information as required. Database 20 of CAMS 10 (shown in FIG. 1) receives, stores, and updates various data elements. For example, Deal Activity Information Section (DAIS) 90 receives, stores and updates information relating to Deal Activity, Deal Status, Deal Milestone Stages or Process Steps, Deal Approval Level, and other related Deal Information. Deal Activity refers to a Number of deals for a specific financial reporting period. While Deal Status is classified or coded as active, close/completed, or terminated depending on the status of the deal. Deal Milestone Stages or Process Steps are categorized into several groups including, but not limited to, qualified lead (QL), pre-proposal issue (PIC), proposal issue, deal awarded, deal presented to approval committee (often referred to as DAM Held), approved, and closed. DAIS 90 further receives and stores information about a Deal Approval Level since different deal approval levels at the business entity drives different costs. Various Deal Approval Levels include approval level at a Headquarter (HQ) level, at a Board Level, and at a Division level. Other approval levels are possible and may be created when necessary.

Organizational Information Section (OIS) 94 includes information pertaining to organization structure and associated business units. A business unit is defined as a profit and loss center. For example, a Structured Finance Group (SFG) of the business entity is organized by industry groups such as Telecom, Energy, and Transportation and Industrial (T&I). Once the business units are defined, each of the product categories under the business unit is created to track operating expenses by each product categories. Product categories include, but are not limited to, loan, lease, common equity, and preferred equity.

Operating Expenses Information Section (OEIS) 96 includes Operating Expenses by Business Unit and other related information.

Products/Processes Information Section (PPIS) 98 includes information about various product categories and processes utilized by the business entity in managing their business. PPIS 98 further includes information about Product categories including, but not limited to, loan, lease, common equity, and preferred equity. Time spent per process as a percent (%) of total year is also accumulated by each process category for each industry group. PPIS 98 further includes the average cycle time from qualified lead to close in days by business unit, by product, and other measures which are useful in computing process efficiency for each industry group. System 10 is capable of storing information, tracking information on a real time basis, storing information on a real time basis, and updating stored information by adding the new information to centralized database 20 on a real time basis to provide up-to-date information instantaneously to the user upon a request. Server system 12 allows addition of new information, deletion of the current information, and editing of the current information stored in database 20. Database 20 is restricted from unauthorized access by ensuring proper authentication procedures.

System 10 accumulates a variety of personal and confidential data for the business entity. Therefore, system 10 has different access levels to control and monitor the security of the system. Authorization for access is assigned by system administrators on a need-to-know basis. In an alternative embodiment, system 10 provides access based on job functions. In yet another embodiment of the invention, system 10 provides access based on positions and management authority within the business entity. The administration/editing capabilities within system 10 are also restricted to ensure that only authorized individuals have access to modify or edit the information that already exists in the system. These internal controls with reference to system security help system 10 to manage and control access to the information.

The architectures of system 10 as well as various components of system 10 are exemplary only. Other architectures and database arrangements are possible and can be utilized in connection with practicing the processes described below.

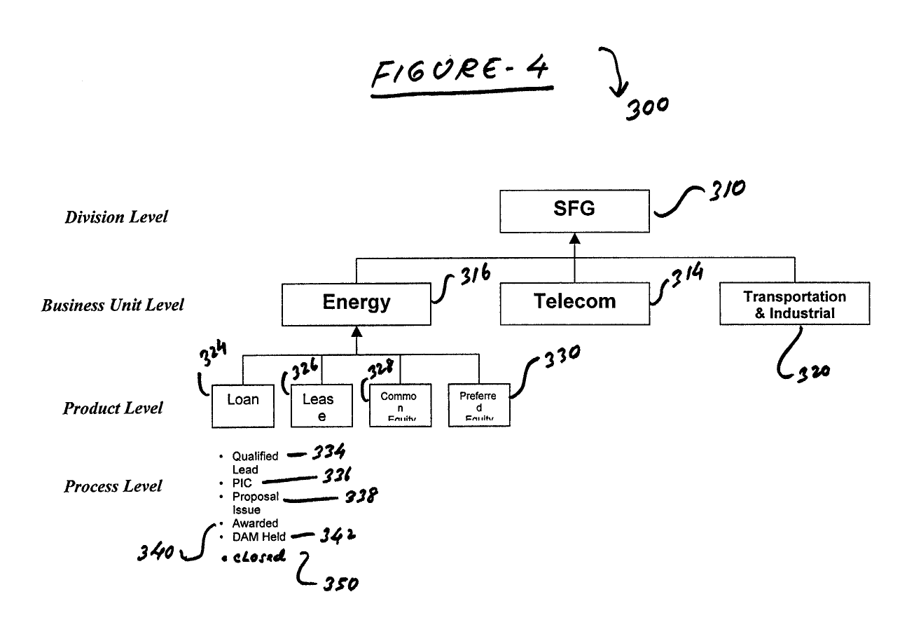

FIG. 4 is an exemplary embodiment of an organizational structure 300 as utilized by CAMS 10 in computing and allocating operating expenses. The business entity has several divisions, one of which is a Structured Finance Group (SFG) 310. SFG 310 of the business entity is organized by industry groups such as Telecom Group 314, Energy Group 316, and Transportation and Industrial (T&I) Group 320. Once the business units are defined, each of the product categories under the business unit is created to track operating expenses by each product category. Product categories under Energy Group 316 include loan 324, lease 326, common equity 328, and preferred equity 330. Process levels as categorized by the Energy Group 316 include Qualified Lead (QL) 334, Pre-proposal Issue (PIC) 336, Proposal Issue 338, Deal Awarded 340, Deal Presented to Approval Committee (often referred to as DAM Held) 342, and Closed 350.

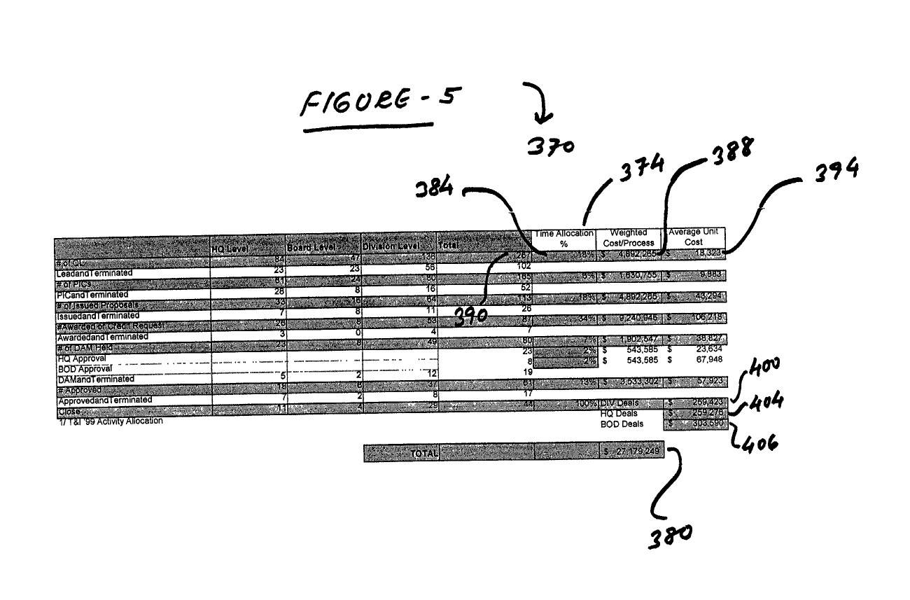

In an exemplary embodiment, CAMS 10 utilizes organizational structure 300 in allocating operating expenses. CAMS 10 implements a two step process model, also referred to as a cost allocation model, in allocating operating expenses. First, CAMS 10 allocates operating expenses to the business unit's processes and computes the average deal cost. Second, CAMS 10 calculates the deal cost per product by adjusting the average deal cost to reflect complexity differences between products. The adjusting is necessary because each product (i.e. Loan, Lease, Common Equity, Preferred Equity, etc.) tends to have a different level of complexity, which drives different processes and costs. FIGS. 5 through 11 describe the step-by-step process utilized by CAMS 22 in computing operating expenses allocation and generating management reports that are essential in decision making process.

FIG. 5 is an exemplary embodiment of a user interface 370 identifying allocation of operating expenses to the business unit's processes and computation of an average deal cost. FIG. 5 shows the cost allocation of the operating expenses to the Business Unit's processes. The cost allocation of the operating expenses is a function of taking Time Allocation percentage per process 374 (i.e. time spent questionnaire sent to employees to estimate their total time spent by process as a percentage of total hours worked for a given time period) and multiplying it to the actual operating expense. For instance, in the example below, Transportation & Industrial (T&I) 320 (shown in FIG. 4) spent $27.2 million 380 in operating expenses for total year 1999. The operating expense represents the expenses related to all products (i.e. loans, lease, common equity, preferred equity, etc.) at all process levels (i.e. QL 334, PIC 336, Proposal Issue 338, Deal Awarded 340, DAM Held 342, and Closed 350). T&I 320 spent eighteen percent 384 of their time working on qualified leads. Therefore, it cost T&I 320, $4.8 million 388 in expenses to generate qualified leads. After computing the cost per process, CAMS 10 calculates the average deal cost per process. Continuing with the example, T&I 320 had two hundred sixty seven qualified leads 390 in 1999. The cost allocation model divides the $4.8 million 388 by two hundred sixty seven qualified leads 390 to determine the average cost of $18,323 per qualified lead 394. In total, the average deal cost for division level 400 is $259,423 for an average deal that is approved at the divisional level. CAMS 10 further computes that the average deal cost for a deal approved at the headquarter level 404 is $259,276 and the average deal cost for a deal approved at the board of director's level 406 is $303,590. After computing the average deal cost for division level 400, headquarter level 404, and board of director's level 406, the cost allocation model adjusts the average deal costs to reflect product differences in complexity and cost.

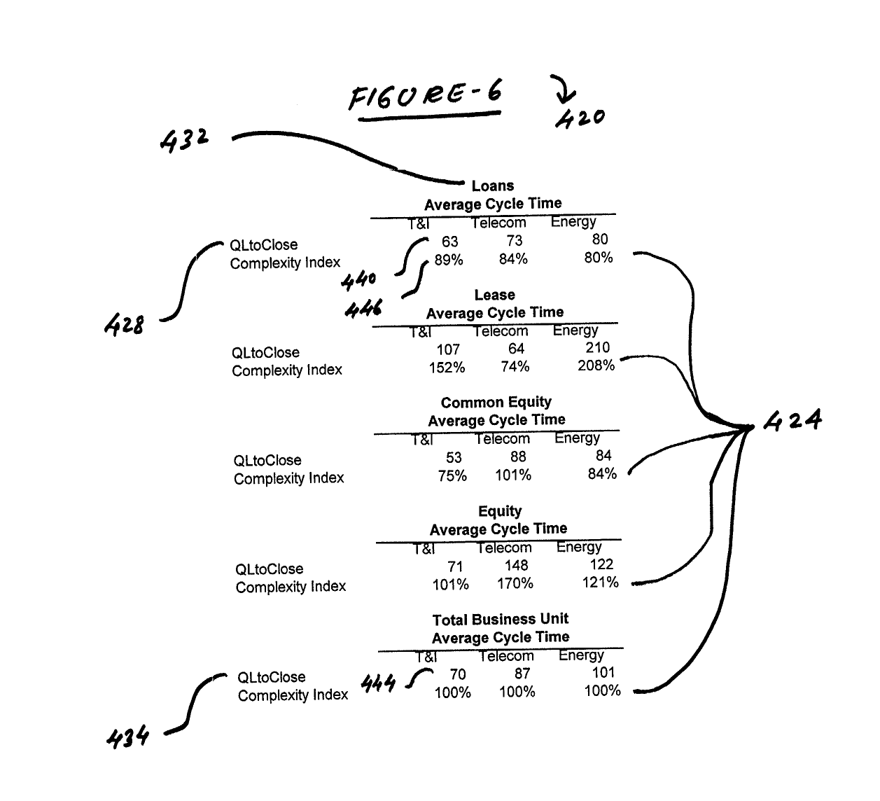

FIG. 6 is an exemplary embodiment of a user interface 420 identifying a Product Complexity Index 424. Product Complexity Index 424 is an average cycle time 428 for each product 432 as a percent of a total business unit cycle time 434. For example, T&I average cycle time for a loan is Sixty-three days 440 from qualified lead to close. The average cycle time for total T&I is Seventy days 444. Therefore, complexity index 446 for a T&I loan is determined to be 89% (63 days divided by 70 days). After determining Product Complexity Index 424, the cost allocation model adjusts the average deal cost by multiplying the Product Complexity Index with the average deal costs.

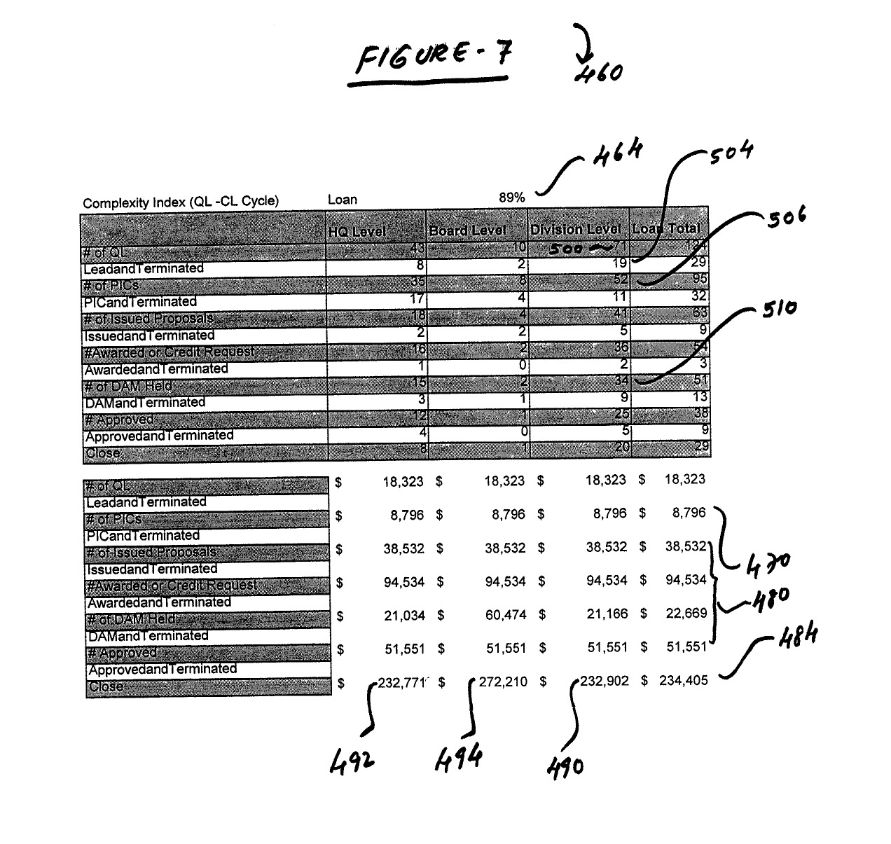

FIG. 7 is an exemplary embodiment of a user interface 460 depicting the overall adjustments to average deal cost based on Product complexity Index 424 (shown in FIG. 6) for a loan product. T&I Loan Complexity Index 464 (also shown in FIG. 6 as reference numeral 446) of 89% is multiplied with average cost by processes with the exception of qualified leads. For example, loan complexity index 464 is multiplied with average deal cost relating to PIC (shown in FIG. 5) $9,883, which results in an average deal cost of $8,796,470 adjusted for PIC based on the complexity index. CAMS 10 first computes the adjusted average deal cost 480 for each step of the loan process and then computes the total adjusted average deal cost 484 for a loan by adding adjusted average deal cost 480 for each step of the process. Based on the computation, the total adjusted average deal cost 484 for a loan product is $234,405. Since the approval level also drives different costs, a loan that requires Divisional Approval 490 costs $232,902, business entity's Headquarter Approval 492 costs $232,771, and Board Approval 494 costs $272,210, respectively. User interface 460 further identifies the breakdown of all deals at each process step. For example, T&I had seventy-one qualified leads 500 out of which nineteen leads were terminated 504, leaving fifty-two leads 506 at PIC level. As shown, out of seventy-one qualified leads 500, thirty-four deals reached DAM Held 510 requiring divisional approval.

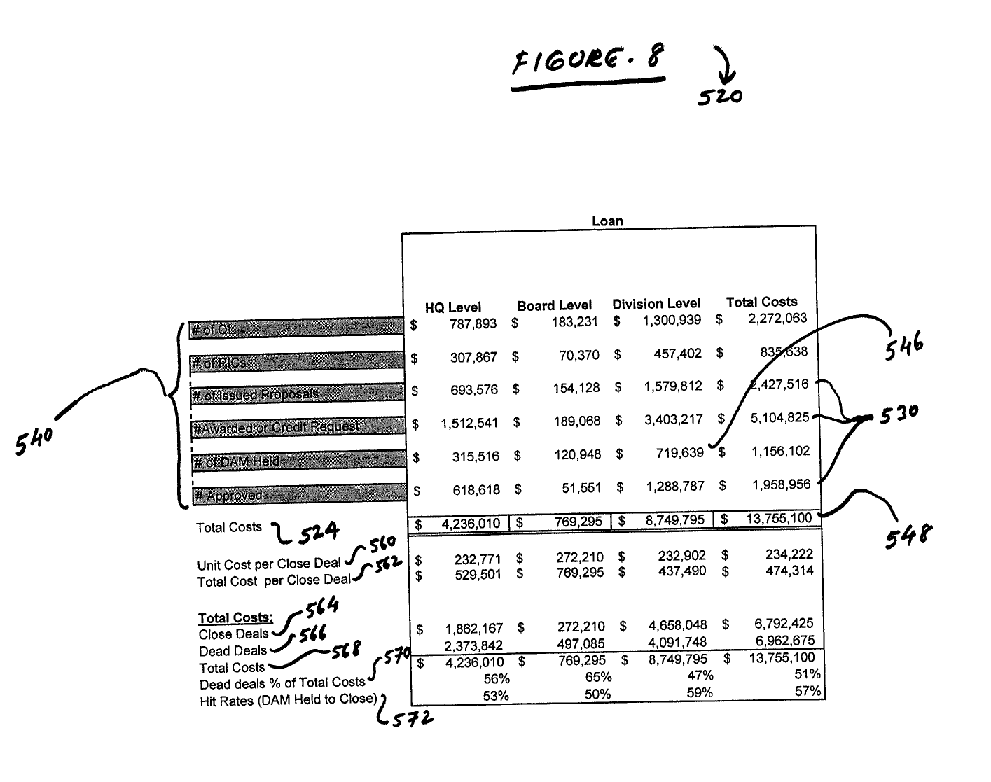

FIG. 8 is an exemplary embodiment of a user interface 520 providing a breakdown of costs for a given product (i.e. loan) for each of the separate process steps. The cost allocation model computes total costs 524 for all products by process 530. The cost allocation model multiplies average product deal cost for each process step 540 (QL, PIC, Issued Proposal, Award, and DAM Held) by number of deals (shown in FIG. 7). For instance, T&I had thirty-four deals that reached DAM Held 510 (shown in FIG. 7) that required divisional approval. The cost allocation model determined a $719,639 cost for divisional level 546 by multiplying thirty-four DAM Held deals 510 (shown in FIG. 7) by the average product/process cost of $21,166 (shown in FIG. 7). Total costs 524 for T&I Loans as developed by cost allocation model is $13.8 million 548. The cost allocation model further determines and displays a Unit Cost per Close Deal 560, a Total Cost per Close Deal 562, Total Costs per Close Deals 564, Total Costs for Dead Deals 566, Total Costs 568, Dead Deals as a Percentage of Total Costs 570 and Hit Rates 572.

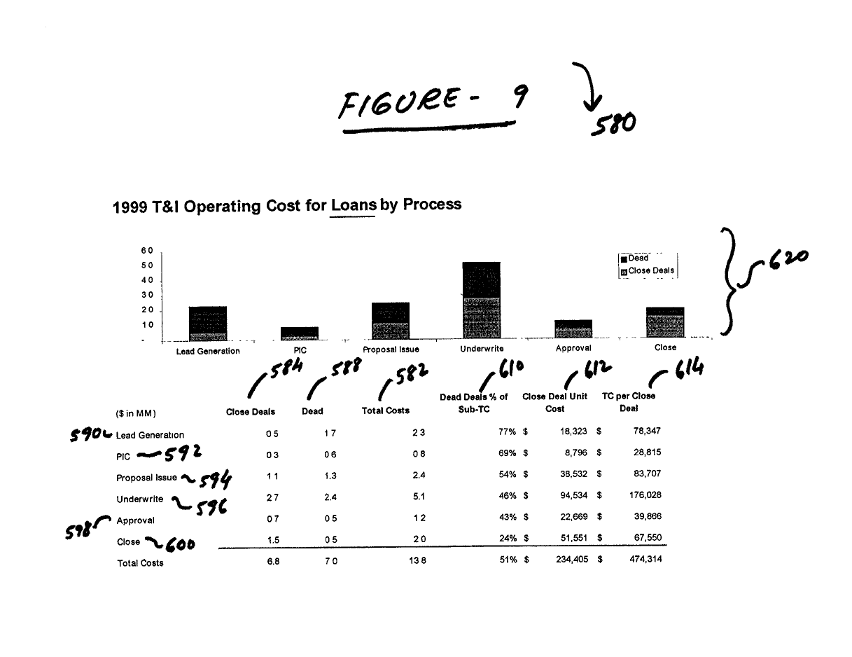

FIGS. 9 through 11 are exemplary embodiments of management reports generated by CAMS 10. Theses reports summarize the activity costs by product and process for each Business Unit. The reports are useful for management to make strategic decisions.

FIG. 9 is an exemplary embodiment of a “T&I Operating Cost for Loans by Process” report 580 which lists a total cost 582 in millions of dollars including a breakdown for close deals 584 costs and dead deals 588 costs. Report 580 further identifies costs by various categories including a Lead Generation category 590, a PIC category 592, a Proposal Issue category 594, an Underwrite category 596, an Approval category 598, and a Close Deal category 600. Report 580 further downloads and displays Dead Deals as a Percentage of Sub Total Cost for a given process step 610, a Close Deal Unit Cost 612, and a Total Cost per Close Deal 614. Report 580 further displays a bar chart 620 depicting a pictorial relationship between Dead Deals and Close Deals. Report 580 exemplifies that the T&I underwriting process has a high terminated/dead deal costs ratio of 51% thereby forcing management's attention to take corrective action in that area to reduce costs.

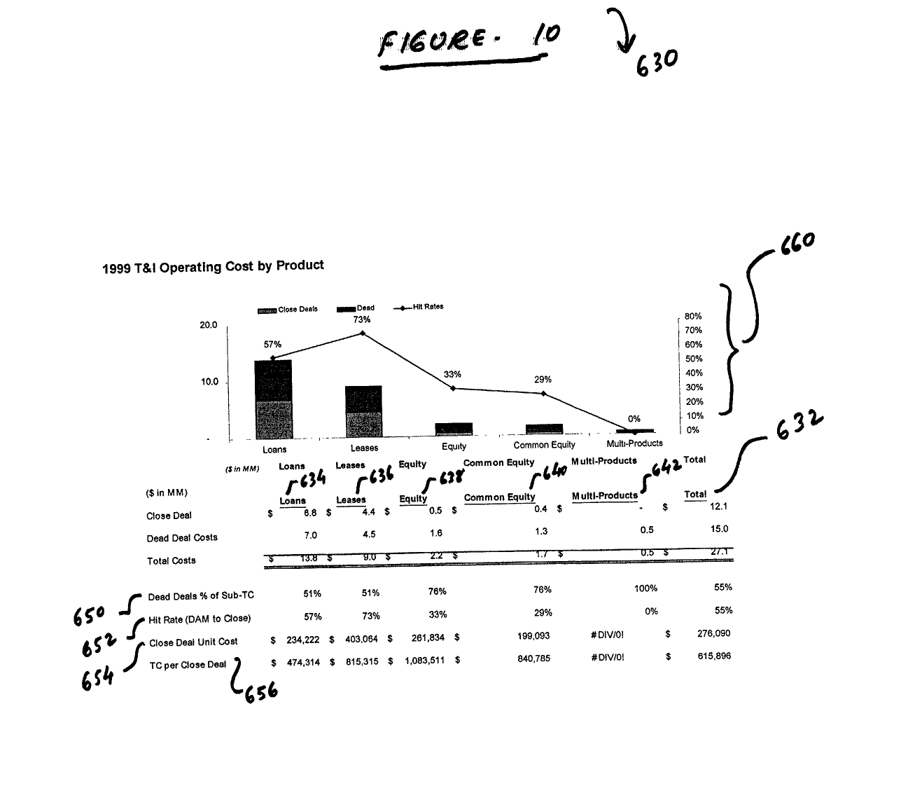

FIG. 10 is an exemplary embodiment of a “T&I Operating Cost by Product” report 630 which lists a total cost 632 in millions of dollars including a breakdown for costs for various product categories including costs for Loans 634, Leases 636, Equity 638, Common Equity 640, and costs for Multi-Products 642. Report 630 further identifies Dead Deals as a Percentage of Sub Total Cost for a given Product category 650, a Hit Rate 652, Close Deal Unit Cost 654, and a Total Cost per close Deal 656. Report 630 further displays a bar chart 660 depicting a pictorial relationship among Dead Deals, Close Deals and Hit Rates.

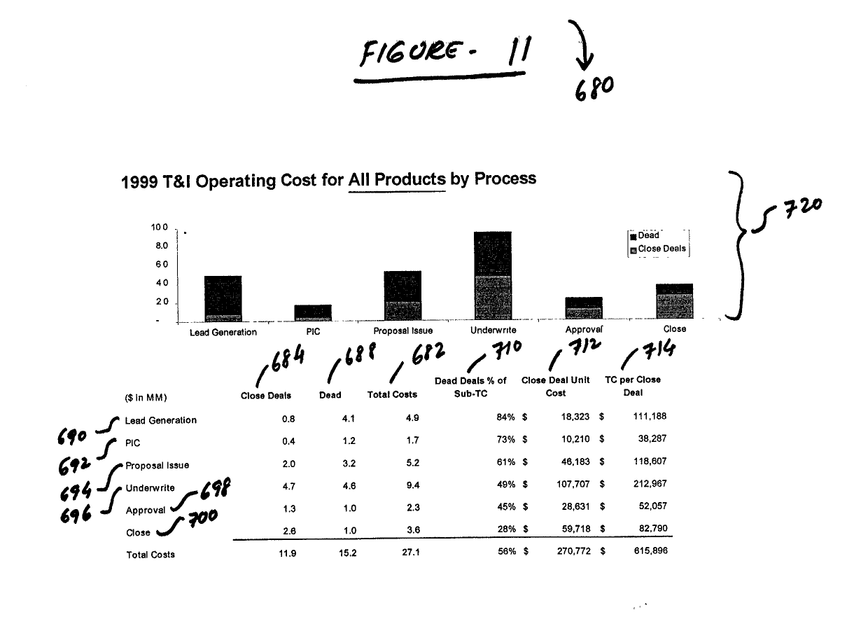

FIG. 11 is an exemplary embodiment of a “T&I Operating Cost for All Products by Process” report 680 which lists a total cost 682 in millions of dollars including a breakdown for Close Deals 684 costs and Dead Deals 688 costs. Report 680 further identifies costs by various categories including a Lead Generation category 690, a PIC category 692, a Proposal Issue category 694, an Underwrite category 696, an Approval category 698, and a Close Deal category 700. Report 680 further downloads and displays Dead Deals as a Percentage of Sub Total Cost for a given process step 710, a Close Deal Unit Cost 712, and a Total Cost per Close Deal 714. Report 680 further displays a bar chart 720 depicting a pictorial relationship between Dead Deals and close Deals.

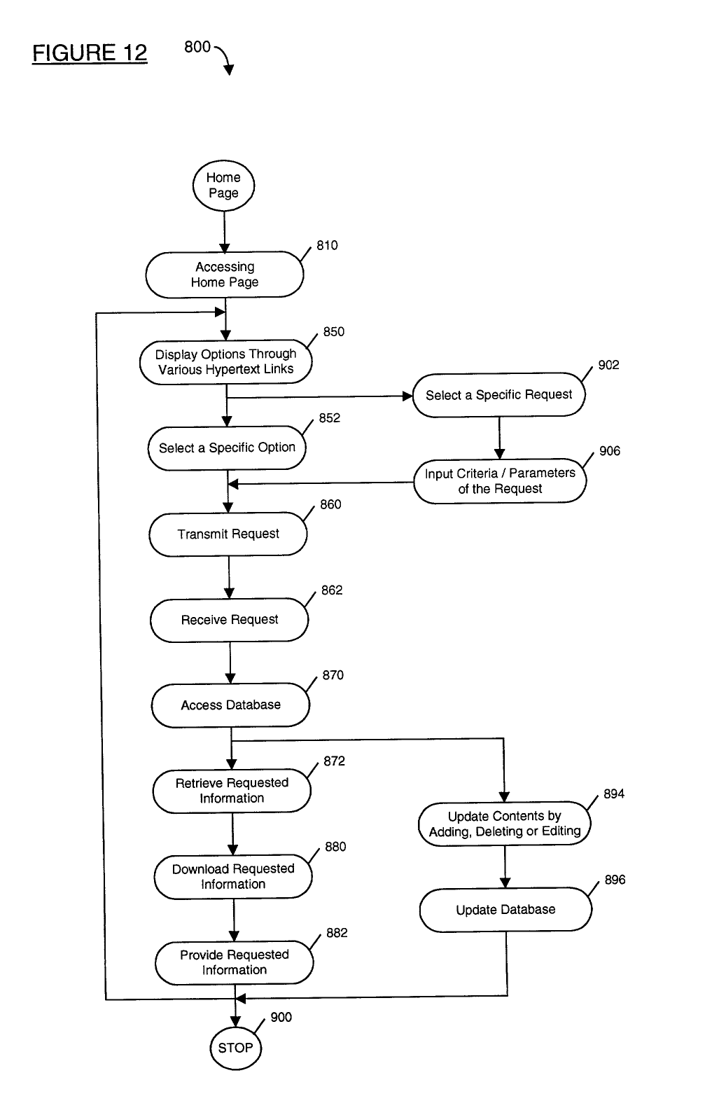

FIG. 12 is a flow chart 800 for Cost Allocation Management System (CAMS) 10 (shown in FIG. 1). Initially, the user accesses 810 a home page (not shown) of the web site through client system 14 (shown in FIG. 1). The home page displays several options 850 including updating the database, searching the database, or printing one of the reports identified in FIGS. 9 through 11. Once the user selects 852 a specific option from the various hypertext links, the request is transmitted 860 to server system 12. Selecting 852 the option is accomplished either by the click of a mouse or by a voice command. Once server system 12 (shown in FIG. 1) receives 862 the request, server system 12 accesses 870 database server 16 and retrieves 872 the requested information from database 20 (shown in FIG. 1). The requested information is downloaded 880 and provided 882 to client system 14 from server 12. The user continues to search database 20 for other information or exits 900 from CAMS 10.

The user updates 894 the contents of the database by adding, deleting or editing the contents of database 20 through a displayed user interface. After updating 894 the contents, the user selects an option to update the database 896. The user may continue the process or exit from the system.

In another embodiment, the home page displays several options identified above and also displays the options for retrieving various management reports. If the user wishes to obtain management reports, the user may obtain the reports by selecting 902 a specific hypertext link. Once the user selects 902 a hypertext link, the user then inputs 906 Criteria/Parameters of the report and transmits 860 a request to the server system by selecting a submit button (not shown). Transmitting 860 the request directs server system 12 to retrieve 872 the data from centralized database 20 and provides 882 the data to the user on the user's interface in a pre-determined format.

In one other embodiment, client system 14, as well as server system 12, are protected from access by unauthorized individuals. As described, CAMS 10 includes an interactive searchable database 20 for all operating expenses, processes, and products related information which provides flexibility to employees as well as management to maintain business information up-to-date.

While the invention has been described in terms of various specific embodiments, those skilled in the art will recognize that the invention can be practiced with modification within the spirit and scope of the claims.

What is claimed is:

1. A method for allocating operating expenses to deal activity using a network-based system including a server system coupled to a centralized database and at least one client system, said method comprising the steps of:
receiving business information;
allocating operating expenses to a business unit's processes;
computing an average deal cost;
calculating deal costs per product by adjusting the average deal cost to reflect complexity differences between products since each product tends to have a different level of complexity that drives different processes and costs; and
providing various management reports to track operating expenses by different categories to facilitate strategic decision making processes and improve operational productivity.

2. A method according to claim 1 wherein said step of receiving information further comprises the step of inputting at least one of a Number of Deals for a Specific Financial Reporting Period, Time spent per process as a percentage of Total Year, Deal Activity Segmentation Factors, Operating Expenses by a Business Unit, and an Average Cycle Time from Qualified Lead to Close in Days by Business Unit by Product Name.

3. A method according to claim 2 wherein Deal Activity Segmentation Factors include at least one of a Name of a Business Unit, a Product Name, a Deal Status identifying whether the Deal is Active, Close or Terminated, a Deal Milestone Stages, a Deal Approval Level.

4. A method according to claim 3 wherein Product Names include at least one of a Loan, a Lease, a Common Equity, and a Preferred Equity.

5. A method according to claim 3 wherein Deal Milestone Stages include at least one of a Qualified Lead, Pre-Proposal Issue, Proposal Issue, Deal Awarded, Presented to Approval Committee and, Approved and Closed.

6. A method according to claim 1 wherein said step of receiving business information further comprises the step of storing business information.

7. A method according to claim 6 wherein said step of storing business information further comprises the steps of:
tracking business information on a real time basis;
storing business information on a real time basis; and
updating the centralized database with revised business information on a real time basis to provide up-to-date information instantaneously to the user upon a request.

8. A method according to claim 7 wherein said step of updating the centralized database with revised business information further comprises at least one of adding new information, deleting the current information and editing the current information stored in the database.

9. A method according to claim 7 wherein said step of updating the centralized database further comprises the step of entering information on-line.

10. A method according to claim 2 wherein said step of inputting information further comprises the step of entering information at least through one of a voice activation command and a device connected to the client system.

11. A method according to claim 1 wherein said step of providing various management reports in response to an inquiry further comprises the steps of:
downloading requested information from a server system; and
displaying requested information on a client system in response to the inquiry.

12. The method according to claim 11 wherein said step of displaying information further includes the step of displaying an HTML document downloaded by the server system.

13. A method according to claim 1 wherein said step of providing various management reports further comprises the step of printing requested information in a pre-determined format.

14. A method according to claim 1 wherein said step of providing various management reports further comprises the steps of:
printing at least one of Operating Cost by Product identifying Total Costs, Close Deal Costs, Dead Deal Costs, Hit Rate, Close Deal Unit Cost, Total Cost per Close Deal and Operating Cost by Process identifying Cost associated with Lead Generation, Cost associated with PIC, Cost associated with Proposal Issue, Cost associated with Underwritten Deals, Cost associated with Deals Approved, Cost associated with Deals Closed, and Cost associated with all Deals;
printing at least one of an Operating cost for Loans by Process Report, an Operating Cost by Product Report, and an Operating cost for all Products by Process Report; and
printing at least one of an Operating costs for Leases by Process Report, an Operating costs for Equity by Process Report, an Operating costs for Common equity by Process Report, and an Operating costs for Preferred Equity by Process Report.

15. A method according to claim 1 wherein said step of providing various management reports further comprises the steps of:
determining at least one of average deal unit costs, beginning and ending inventory for active deals, total cost for terminated and closed deals, operation productivity, and product pricing; and
printing at least one of average deal unit costs, beginning and ending inventory for active deals, total cost for terminated and closed deals, operation productivity, and product pricing.

16. The method according to claim 1 wherein the client system and the server system are connected via a network and wherein the network is one of a wide area network, a local area network, an intranet and the Internet.

17. A method for allocating operating expenses to deal activity based on various data inputs to determine operations productivity, product pricing, and strategic decision making, said method comprising the steps of:
receiving business information which includes at least one of at least one of a Number of Deals for a Specific Financial Reporting Period, Time spent per process as a percentage of Total Year, Deal Activity Segmentation Factors, Operating Expenses by a Business Unit, and an Average Cycle Time from Qualified Lead to Close in Days by Business Unit by Product Name;
allocating operating expenses to a business unit's processes;
computing an average deal cost;
calculating deal costs per product by adjusting the average deal cost to reflect complexity differences between products since each product tends to have a different level of complexity that drives different processes and costs; and
providing various management reports to track operating expenses by different categories to facilitate strategic decision making processes.

18. A method according to claim 17 wherein said step of providing various management reports further comprises the steps of:
printing at least one of Operating Cost by Product identifying Total Costs, Close Deal Costs, Dead Deal Costs, Hit Rate, Close Deal Unit Cost, Total Cost per Close Deal and Operating Cost by Process identifying Cost associated with Lead Generation, Cost associated with PIC, Cost associated with Proposal Issue, Cost associated with Underwritten Deals, Cost associated with Deals Approved, Cost associated with Deals Closed, and Cost associated with all Deals;
printing at least one of an Operating cost for Loans by Process Report, an Operating Cost by Product Report, and an Operating cost for all Products by Process Report; and
printing at least one of an Operating costs for Leases by Process Report, an Operating costs for Equity by Process Report, an Operating costs for Common equity by Process Report, and an Operating costs for Preferred Equity by Process Report.

19. A web-based system for allocating operating expenses utilizing a cost allocation model, said system comprising:
a client system comprising a browser;
a data storage device for storing information;
a server system configured to be coupled to said client system and said database, said server system further configured to:
receive business information;
allocate operating expenses to a business unit's processes;
compute an average deal cost;
calculate deal cost per product by adjusting the average deal cost to reflect complexity differences between products; and
provide various management reports to track operating expenses by different categories.

20. A system according to claim 19 wherein said server system further configured to receive at least one of a Number of Deals for a Specific Financial Reporting Period, Time spent per process as a percentage of Total Year, Deal Activity Segmentation Factors, Operating Expenses by a Business Unit, and an Average Cycle Time from Qualified Lead to Close in Days by Business Unit by Product Name.

21. A system according to claim 20 wherein Deal Activity Segmentation Factors include at least one of a Name of a Business Unit, a Product Name, a Deal Status identifying whether the Deal is Active, Close or Terminated, a Deal Milestone Stages, a Deal Approval Level.

22. A system according to claim 20 wherein Product Names include at least one of a Loan, a Lease, a Common Equity, and a Preferred Equity.

23. A system according to claim 20 wherein a Deal Milestone Stage includes at least one of a Qualified Lead, Pre-Proposal Issue, Proposal Issue, Deal Awarded, Presented to Approval Committee and, Approved and Closed.

24. A system according to claim 19 wherein said server system further configured to store business information.

25. A system according to claim 24 wherein said server system further configured to:
track business information on a real time basis;
store business information on a real time basis; and
update the centralized database with revised business information on a real time basis to provide up-to date information instantaneously to the user upon a request.

26. A system according to claim 25 wherein said server system further configured to update the database by at least one of adding new information, deleting the current information and editing the current information stored in the database.

27. A system according to claim 25 wherein said server system further configured to update the database instantaneously by accepting the business information entered on-line.

28. A system according to claim 25 wherein said server system further configured to update the database instantaneously by accepting the business information at least through one of a voice activation command and a device connected to the client system.

29. A system according to claim 19 wherein said server system further configured to:
download requested information from a server system; and
display requested information on a client system in response to the inquiry.

30. A system according to claim 19 wherein said server system further configured to print requested information in a pre-determined format.

31. A system according to claim 19 wherein said server system further configured to display an HTML document downloaded by the server system.

32. A system according to claim 19 wherein said server system further configured to print at least one of Operating Cost by Product identifying Total Costs, Close Deal Costs, Dead Deal Costs, Hit Rate, Close Deal Unit Cost, Total Cost per Close Deal and Operating Cost by Process identifying Cost associated with Lead Generation, Cost associated with PIC, Cost associated with Proposal Issue, Cost associated with Underwritten Deals, Cost associated with Deals Approved, Cost associated with Deals Closed, and Cost associated with all Deals.

33. A system according to claim 19 wherein said server system further configured to print at least one of an Operating cost for Loans by Process Report, an Operating Cost by Product Report, and an Operating cost for all Products by Process Report.

34. A system according to claim 19 wherein said server system further configured to print at least one of an Operating costs for Leases by Process Report, an Operating costs for Equity by Process Report, an Operating costs for Common equity by Process Report, and an Operating costs for Preferred Equity by Process Report.

35. A system according to claim 19 wherein said server system further configured to:
determine at least one of average deal unit costs, beginning and ending inventory for active deals, total cost for terminated and closed deals, operation productivity, and product pricing; and
print at least one of average deal unit costs, beginning and ending inventory for active deals, total cost for terminated and closed deals, operation productivity, and product pricing.

36. The system according to claim 19 wherein the client system and the server system are connected via a network and wherein the network is one of a wide area network, a local area network, an intranet and the Internet.

37. A system according to claim 19 wherein said client system is further configured with:
a displaying component; and
a sending component to send an inquiry to the server system so that the server system can process and download the requested information to the client system.

38. A system according to claim 37 wherein the sending component functions in response to a click of a mouse button.

39. A system according to claim 37 wherein the sending component functions in response to a voice command.

40. The client system of claim 37 wherein said system is further configured to be protected from access by unauthorized individuals.

41. A system according to claim 19 wherein said server system is further configured with a displaying component for displaying various user interfaces to the user, a receiving component for receiving an inquiry to provide information from one of a plurality of users, a collection component for collecting information from users into the centralized database, a tracking component for tracking information on an on-going basis, and an accessing component for accessing the centralized database and causing the retrieved information to be displayed on the client system.

42. A system according to claim 41 wherein said server system further configured with a processing component for searching and processing received inquiries against the data storage device containing a variety of information collected by the collection component.

43. A system according to claim 41 wherein said server system further configured with a retrieving component to retrieve information from the data storage device.

44. A system according to claim 41 wherein said server system further configured with an information fulfillment component that downloads the requested information after retrieving from the data storage device to the plurality of users in the order in which the requests were received by the receiving component.

45. A system according to claim 19 wherein said server system further configured to receive input directly from a plurality of individuals and update the centralized database to reflect the current allocation of operating expenses by the business unit at a given time.

46. A computer program embodied on a computer readable medium for allocating operating expenses to facilitate strategic decision making process, comprising:
a code segment that receives business information;
a code segment that allocates operating expenses to a business unit's processes;
a code segment that computes an average deal cost;
a code segment that calculates deal cost per product by adjusting the average deal cost to reflect complexity differences between products since each product tends to have a different level of complexity that drives different processes and costs; and
a code segment that provides various management reports to track operating expenses by different categories to facilitate strategic decision making process and improve operational productivity.

47. The computer program as recited in claim 46 further includes a code segment that:
tracks information on a real time basis; and
stores information on a real time basis by updating stored information by adding the new information to the centralized database on a real time basis to provide up-to date information instantaneously to the user upon a request.

48. The computer program as recited in claim 47 further includes a code segment that allows at least one of adding new information, deleting the current information and editing the current information stored in the database.

49. The computer program as recited in claim 47 further includes a code segment that enters information on-line.

50. The computer program as recited in claim 47 further includes a code segment that enters information at least through one of a voice activation command and a device connected to the client system.

51. The computer program as recited in claim 47 further includes a code segment that prints requested information.

52. The computer program as recited in claim 47 further includes a code segment that displays an HTML document downloaded by the server system.

53. The computer program as recited in claim 47 wherein the network is a wide area network operable using a protocol including at least one of TCP/IP and IPX.

54. The computer program as recited in claim 47 wherein the data is received from the user via a graphical user interface.

55. The computer program as recited in claim 47 wherein the client system and the server system are connected via a network and wherein the network is one of a wide area network, a local area network, an intranet and the Internet.

56. The computer program as recited in claim 47, and further comprising a code segment that monitors the security of the system by restricting access to unauthorized individuals.
